(19) United States
(12) Patent Application Publication
(10) Pub. No.: US 2008/0044512 A1
(43) Pub. Date: Feb. 21, 2008

(54) Mould And Method For Producing A Panel That Is Embedded In Or Surrounded By Injection -Moulded Or Expanded Plastic

(75) Inventor: Robert Koch, Langerringen (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 11/577,470

(22) PCT Filed: Oct. 11, 2005
(86) PCT No.: PCT/DE05/01819

§ 371 Date: Apr. 18, 2007

(30) Foreign Application Priority Data
Oct. 18, 2004 (DE) 10 2004 050 861.5

(51) Int. Cl. B29C 37/02; B29C 39/28

(52) U.S. Cl. 425/553; 264/276

(57) ABSTRACT

A molding tool and process for producing a plate which has been foamed, injected or cast in situ with plastic, for example, a cover provided with a plastic frame for a motor vehicle roof. To prevent burr formation, at least one wire (13, 14) which can be heated is provided in the region of at least one parting line between adjacent tool parts (11, 12, 6) to eliminate excess plastic material of the plastic frame (8).

### BACKGROUND OF THE INVENTION

1. Field of the Invention

The invention relates to a molding tool comprised of a plurality of tool parts and to a process for producing a plate which has been foamed, injected or cast in place with plastic, for example, a cover provided with a plastic frame for a motor vehicle roof.

2. Description of Related Art

Such a molding tool and such a process for producing a cover of an openable vehicle roof are known, for example, from German Patent Application DE 42 38 889 A1 and corresponding U.S. Pat. No. 6,099,779. A receiving groove for the seal profile of this cover is produced in a plastic frame which has been peripherally foamed or injected onto the cover by a molding tool which has several slides which laterally border one another via a parting line and which have a shaping profile on the front side which is complementary to the sealing profile holding groove which is to be produced.

In the case of a cover for an openable vehicle roof, there are four slides on the molding tool which are movably supported and which border one another in the region of the four corners of the cover plate, over a respective parting line. These four slides are retracted at the same time from the still soft plastic mass of the plastic frame. During retraction, material remains in the sealing profile holding groove which has been formed in the region of the parting lines between the slides; the material forms a burr which must be subsequently tediously removed, for example, ground off, so that it is ensured that the seal profile which has been later inserted properly into the seal profile groove is held completely in this groove without projecting locally due to the burrs. This problem relates especially to seal profiles which have an anchoring part that completely fills the seal profile groove. The problems of formation of unwanted burrs arise due to the inevitable tolerances of the tool parts, generally also on the parting lines between the upper tool and the lower tool. When the tool is opened and when the workpiece which has been completely injected in place is removed, in particular, the visible surfaces and edges of the cover must be checked for burrs and the burrs which have been found must be removed by manual reworking, such as cutting, grinding or polishing.

### SUMMARY OF THE INVENTION

A primary object of this invention is, thus, to devise a molding tool and a process for producing a plate which has been foamed, injected or cast in place with plastic, for example, the cover of a vehicle roof, with which formation of burrs in the tool is reduced.

This object is achieved with respect to the molding tool being provided with at least one wire that is heatable for eliminating excess plastic material of the plastic frame and with respect to the process by heating of at least one wire located on the parting line between the tool parts for melting excess plastic material before removing of the plate from the mold.

The invention essentially calls for placing at least one heatable wire on the upper tool and/or a lower tool and/or on the slide of a molding tool, especially in the region of a parting line or an edge of the workpiece; the wire is briefly activated after curing of the plastic frame in the tool before opening of the mold or before drawing the slide. By heating the wire, excess PU material is melted. The residues remain on the tool and are removed when it is cleaned, while the workpiece itself can be removed from the tool largely free of burrs.

The invention is explained in detail below with reference to the accompanying drawings.

### BRIEF DESCRIPTION OF THE DRAWINGS

FIG. 1 is a perspective top view of an openable motor vehicle roof with the cover in the closed position, and

FIG. 2 shows a section through the cover in the edge area in its production in a closed molding tool.

### DETAILED DESCRIPTION OF THE INVENTION

In a fixed vehicle roof 1, there is a roof cutout 17 which can be closed by means of a cover 2 and which can be at least partially cleared by raising its back edge and/or moving the cover 2. Such a cover 2 comprises a cover plate 3 which is preferably produced from a transparent material, such as glass or plastic, a reinforcing frame 4 located underneath the cover plate 3, and a plastic frame 8 which connects the reinforcing frame 4 to the cover plate 3. The reinforcing frame 4 can be made in one part or several parts. The plastic frame 8 which has been produced by injection or injection molding in a molding tool 15 has a groove 7 for holding a seal profile 5 on its outwardly facing edge. The plastic frame is preferably made of polyurethane (PU).

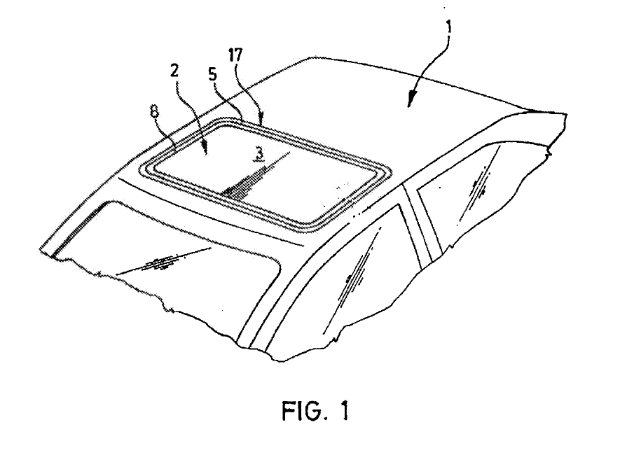

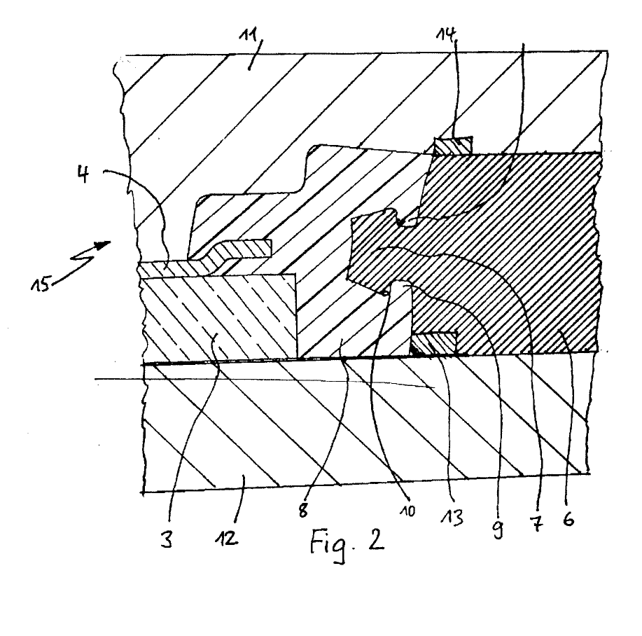

The molding tool 15 is comprised of a lower tool 12, an upper tool 11 and slides 6 which are movably located on the edges extending in their lengthwise direction, i.e., parallel to the edges of the cover plate 3, and which jointly border a mold cavity which corresponds to the entire contour of the cover plate 3, of the reinforcing frame 4 and of the plastic frame 8. The cover 2 in production (FIG. 2) is typically inverted in the molding tool 15 relative to its position of use (FIG. 1).

The plastic frame 8 is provided with a groove 7 that is used to attach the seal profile 5 after removal of the cover 2 from the molding tool 17. The seal profile 5 has a molded part that corresponds in shape to the contour of the groove 7 for engaging in groove 7. The groove 7 of the plastic frame 8 has two opposite undercuts 10 which interact with two projections 9 which have been formed complementary thereto on the plastic frame 8, such that the seal profile 5 is held securely on the plastic frame 8 and is pressed into the groove 7 only by horizontal forces during installation or can be removed to the outside by pulling out for replacement in the case of damage.

To eliminate burrs which may form, there are heatable wires 13, 14 on the upper lower and upper tools 12, 11 in the region of their parting lines relative to the respective adjacent slide 6. The arrangement of the wires 13, 14 is simply exemplary and should not be regarded as limiting. In general, one or more wires can be located on the upper tool 11, on the lower tool 12 and/or on the slides 6 at those points at which burrs typically form. Here, in general, an arrangement of the wires 13, 14 on the upper tool 11 and/or on the lower tool 12 are preferred, since they need only be swung against one another for opening and closing, and in this way, energy supply is simpler than for the movable slides 6.

The wires 13, 14, which have increased electrical resistance are briefly supplied with electricity after curing of the PU material of the plastic frame 8 and before the slide 6 is pulled out and the molding tool 15 is opened. Here, the wires 13, 14 glow briefly at roughly 300° C., and in the joint area between the tool parts 11, 12 and 6 and between them and the plastic frame, excess plastic material which would otherwise have led to burr formation is melted. The temperature of the wires should not rise above 400° C., in any case, to prevent burning of the plastic. To control the temperature, in addition, there can be a temperature sensor which interacts with an electronic control (not shown) or the wires are of PTC material and immediately indicate the temperature value which has been reached by their resistance change as the control temperature rises. However, in the simplest case, a basic time control which is based on an empirical value which has been determined by tests is sufficient for the required heat-up and glow interval.

The term “wires” is defined here both as a wire with a round cross section and also with rectangular, polygonal, oval or similar cross section. The material for the wires 13, 14 can be a metal or metal alloy as well as an electrically conductive ceramic material or an electrically conductive plastic with the corresponding temperature resistance and good separation properties relative to the metal of the molding tool—such as, for example, a ladle coating material.

The heat-up intervals of the wires 13, 14 is preferably roughly 10-20 seconds, and the actual glow phase after reaching the required melting point for melting off the excess plastic is, conversely, preferably less than one second.

A process in accordance with the invention for producing the cover of a motor vehicle roof calls for the cover plate with a reinforcing frame to be inserted into the lower tool of a molding tool, for the molding tool with an appropriate upper tool, and optionally, movably supported slides to be closed, for plastic material to be injected into the cavity of the molding tool, for the plastic material to cure in the molding tool and for heating devices located at the interfaces between the lower tool, upper tool and/or slides to be activated before opening the molding tool or before drawing the slides for melting the excess plastic material.

The wires 13, 14 can be immediately provided in the production of the new molding tools, but they can also be retrofitted on existing molding tools by a groove corresponding to the cross section of the wire being machined into the surface of part of the molding tool facing the parting line for attachment of each of the heating wires.

1-12. (canceled)

13. Molding tool for producing a plate which has been formed in situ with a plastic frame, the molding tool being comprised of a plurality of tool parts, wherein at least one heating wire is provided in a region of at least one parting line between adjacent tool parts, the at least one wire being heatable for eliminating excess plastic material of the plastic frame.

14. Molding tool as claimed in claim 13, wherein the molding tool has a lower tool and an upper tool and wherein said at least one heating wire is provided on each of the molding tools.

15. Molding tool as claimed in claim 13, wherein there is at least one movably supported slide on which there is at least one heating wire.

16. Molding tool as claimed in claim 13, wherein the heating wire is an electrically heated heating wire.

17. Molding tool as claimed in claim 13, wherein the heating wire is made of a metal or metal alloy.

18. Molding tool as claimed in claim 13, wherein the heating wire is made of a plastic material.

19. Molding tool as claimed in claim 13, wherein the heating wire has a resistance characteristic which rises with temperature.

20. Molding tool as claimed in claim 13, wherein the heating wire has a rectangular or polygonal cross section.

21. Molding tool as claimed in claim 13, wherein the temperature of the heating wire is settable by means of a control.

22. Process for producing a plate which has been foamed, injected or cast in situ with plastic in a multipart molding tool, comprising the following process steps:
a) inserting a cover plate and a reinforcing frame into a multipart molding tool,
b) closing the molding tool,
c) injecting a plastic material into a cavity of the molding tool,
d) curing the plastic material,
e) heating at least one wire located at a parting line between the tool parts so as to melt excess plastic material, and
f) opening the molding tool and removing the cover.

23. Process as claimed in claim 22, wherein the temperature during the heating step e) is roughly 300° C.

24. Process as claimed in claim 23, wherein the heat-up interval during the heating step e) is about 10 to 20 seconds.
